(19) United States
(12) Patent Application Publication
(10) Pub. No.: US 2003/0032460 A1
(43) Pub. Date: Feb. 13, 2003

(54) Multi-user hands-free wireless telephone gateway

(76) Inventors: Joseph M. Cannon, Harleysville, PA (US); James A. Johanson, Macungie, PA (US); Philip D. Mooney, Sellersville, PA (US)

Correspondence Address: MANELLI DENSION & SELTER PLLC, 7th Floor, 2000 M Street, N.W., Washington, DC, 20036-3307, US

(21) Appl. No.: 09/924,482

(22) Filed: Aug. 9, 2001

(51) Int. Cl. H04M 1/00

(52) U.S. Cl. 455/569; 455/41

(57) ABSTRACT

A wireless multi-user hands-free gateway particularly suited for a vehicle. The wireless hands-free gateway is capable of wireless operation with any of a plurality of wireless phones established on a piconet network (e.g., a BLUETOOTH™ standard piconet network) within the vehicle. In the disclosed embodiments, the wireless multi-user hands-free gateway automatically identifies users within range, and preferably gives priority use to the user detected or otherwise identified to be the driver of the vehicle. All passengers other than the driver may be similarly prioritized and given access on a first come-first served basis.

### BACKGROUND OF THE INVENTION

1. Field of the Invention

This invention relates generally to wireless phones. More particularly, it relates to devices which permit hands-free wireless phone operation.

2. Background

Wireless telephones, including cellular phones, have proven to be immensely useful and important in today's society. Wireless phones can be seen in all walks of life: at the grocery store, in the park, and perhaps most prominently while driving or riding in a vehicle.

While the benefits of wireless phones are indisputable, there has been increasing concern over their use by drivers of vehicles. Concerns generally focus on the safety issues with respect to the need for a user to physically hold the wireless phone when using it in a vehicle.

As a result, several states have adopted new laws requiring use of a hands-free unit by drivers. A hands-free unit essentially provides a speakerphone capability to a wireless phone, and also typically draws power from the vehicles battery, extending (and even re-charging) the wireless device's battery.

A typical hands-free unit for a vehicle (i.e., in-car speakerphone) provides audio linkeage between a wireless phone in the vehicle and a loudspeaker and microphone. For instance, some conventional ‘wired’ hands-free units physically connect and/or cradle a wireless phone, often providing power and intermixing the phone audio receive path with the stereo system of the vehicle, though not all conventional hands-free units provide power and/or access to the stereo system.

As wireless phones proliferate in our society, it becomes more and more likely that multiple wireless phones may be utilized by separate persons within a single vehicle. While state laws typically relate only to drivers of the vehicle, it is often desirable to allow any wireless telephone within the vehicle to utilize the hands-free unit. This may be possible if all users within the vehicle have the same type wireless phone able to mate with the hands-free unit, but it is not always likely. Moreover, if another wireless phone is already mated with the hands-free unit, it is often easiest and most convenient to merely not utilize the hands-free unit and instead manually handle the wireless phone. Thus, use of a conventional hands-free unit is typically restricted only to the driver of a vehicle.

There is a need for a hands-free unit capable of providing efficient and convenient access to any wireless phone user who happens to be within the vehicle, in a manner which is safe and non-distracting to the driver of the vehicle.

### SUMMARY OF THE INVENTION

In accordance with the principles of the present invention, a wireless hands-free device comprises a piconet front end adapted to establish an audio path with a wireless phone over a piconet network, and a speakerphone functionality module.

A method of providing hands-free functionality to one of a plurality of wireless phones participating in a piconet network in accordance with another aspect of the present invention comprises receiving a request for access to a wireless hands-free gateway from one of the plurality of wireless phones, and providing hands-free functionality to that wireless phone.

### BRIEF DESCRIPTION OF THE DRAWINGS

Features and advantages of the present invention will become apparent to those skilled in the art from the following description with reference to the drawings, in which:

FIG. 1 depicts the presence of four wireless phones in a top view of a vehicle including a multi-user wireless hands-free gateway, in accordance with the principles of the present invention.

FIG. 2 is a detailed block diagram of a multi-user wireless hands-free gateway in accordance with the principles of the present invention.

FIG. 3 is an exemplary vehicle control panel which, once trained with appropriate wireless phone Ids (e.g., phone numbers), allows a driver of the vehicle to identify themselves as such so that their wireless phone is given priority usage of the vehicle's wireless multi-user hands-free unit, in accordance with the principles of the present invention.

FIG. 4 is an exemplary process flow chart showing the training of the vehicle control panel shown in FIG. 3.

FIG. 5 is an exemplary process flow chart showing the usage of the wireless multi-user hands-free gateway by the driver of the vehicle, in accordance with the principles of the present invention.

FIG. 6 is an exemplary process flow chart showing the usage of the wireless multi-user hands-free gateway by a passenger of the vehicle, in accordance with the principles of the present invention.

FIG. 7 is an exemplary process flow chart showing a first option wherein the driver of the vehicle returns a busy or not available signal if an incoming call is received while another passenger in the vehicle is using the wireless multi-user hands-free gateway, in accordance with the principles of the present invention.

FIG. 8 is an exemplary process flow chart showing a second option wherein if an incoming call is received by the driver while another passenger in the vehicle is using the wireless multi-user hands-free gateway, the passenger is directed to terminate use of the wireless multi-user hands-free unit (either by returning to hand mode or by terminating telephone call), to provide priority usage of the wireless multi-user hands-free gateway in accordance with the principles of the present invention.

FIG. 9 shows the use of a driver ID transponder to automatically inform the wireless multi-user hands-free gateway as to which user within range of the BLUETOOTH™ piconet is the driver of the vehicle, in accordance with the principles of the present invention.

### DETAILED DESCRIPTION OF ILLUSTRATIVE EMBODIMENTS

A wireless multi-user hands-free gateway particularly suited for a vehicle. The wireless hands-free gateway is capable of wireless operation with any of a plurality of wireless phones established on a piconet network (e.g., a BLUETOOTH™ standard piconet network) within the vehicle. In the disclosed embodiments, the wireless multi-user hands-free gateway automatically identifies users within range, and preferably gives priority use to the user detected or otherwise identified to be the driver of the vehicle. All passengers other than the driver may be similarly prioritized and given access on a first come-first served basis.

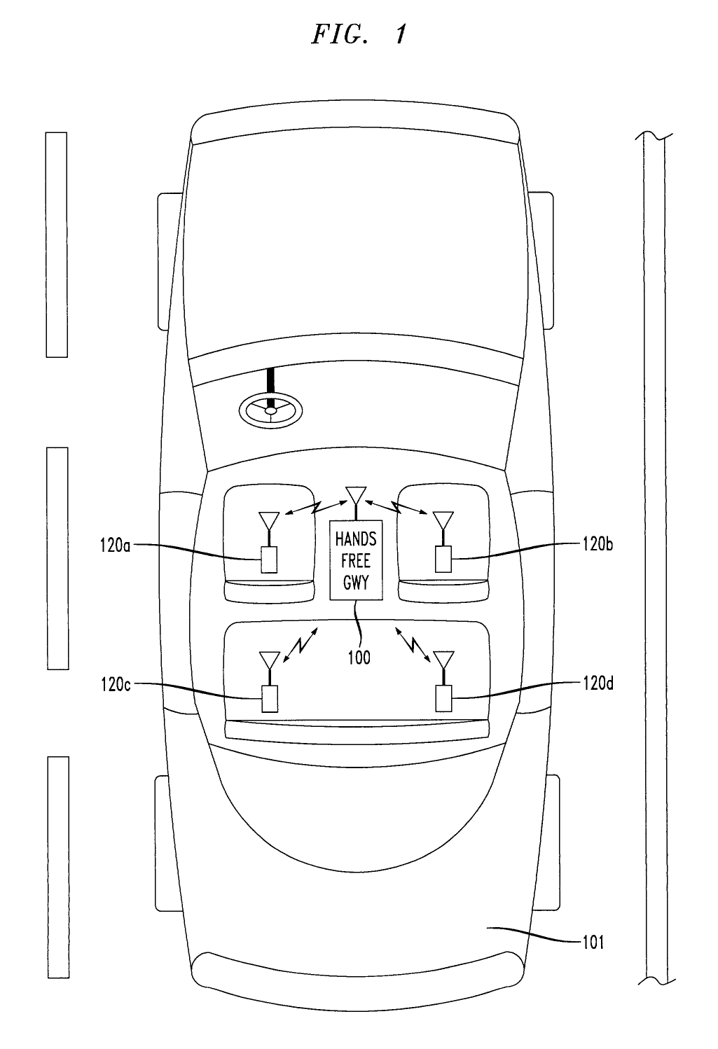

FIG. 1 depicts the presence of four wireless phones in a top view of a vehicle including a multi-user wireless hands-free gateway, in accordance with the principles of the present invention.

In particular, FIG. 1 shows a wireless multi-user hands-free gateway unit 100 installed in a vehicle 101. The hands-free gateway unit 100 may be installed in any convenient location within the vehicle 101, e.g., in the center console, under the dashboard, etc.

The vehicle may accommodate any number of passengers in addition to the driver. The vehicle 101 shown in FIG. 1 accommodates three (3) passengers in addition to the driver. The driver uses a first wireless phone 120a, while the passengers use respective wireless phones 120b, 120c, 120d.

In the given embodiments, the wireless phones (referred to collectively as 120) communicate over a piconet (e.g., a BLUETOOTH™ piconet) established with the wireless multi-user hands-free gateway 100. Use of a wireless communication path between the wireless telephones and the BLUETOOTH™ piconet in the wireless hands-free gateway 100 has the advantage of connecting without any wires and without the user needing to do anything (except bring their wireless phone into the vehicle 101).

Each wireless phone 120 includes a wireless piconet front end in communication with a main processor (e.g., microcontroller, microprocessor, or digital signal processor (DSP)). In the given embodiments, the wireless piconet front ends of both the wireless phones 120 and the wireless hands-free gateway 100 form a wireless piconet with one another.

Piconets, or small wireless networks, are being formed by more and more devices in many homes and offices. In particular, a popular piconet standard is commonly referred to as a BLUETOOTH™ piconet. Piconet technology in general, and BLUETOOTH technology in particular, provides peer-to-peer communications over short distances.

The wireless frequency of the piconets may be 2.4 GHz as per BLUETOOTH standards, and/or typically have a 20 to 100 foot range. The piconet RF transmitter may operate in common frequencies that do not necessarily require a license from the regulating government authorities, e.g., the Federal Communications Commission (FCC) in the United States. Alternatively, the wireless communication can be accomplished with infrared (IR) transmitters and receivers, but this is less preferable because of the directional and visual problems often associated with IR systems.

A plurality of piconet networks may be interconnected through a scatternet connection, in accordance with BLUETOOTH™ protocols. BLUETOOTH network technology may be utilized to implement a wireless piconet network connection (including scatternet). The BLUETOOTH standard for wireless piconet networks is well known, and is available from many sources, e.g., from the web site www.bluetooth.com.

A dedicated one-to-one pairing of a wireless phone to a wireless hands-free gateway using a BLUETOOTH™ piconet is useful. The present invention provides a wireless hands-free gateway which may also communicate with passengers' wireless phones 120b-120d in addition to the driver's cell wireless phone 120a.

In the given embodiments, the wireless multi-user hands-free gateway 100 provides only one audio path (i.e., only one set of loudspeaker(s) and microphone), and thus a selection or arbitration among wireless phone members of the piconet must be made by the wireless multi-user hands-free gateway 100, because more than one wireless phone may be in operation in the vehicle.

Since safety is of the utmost concern, it is desirable that the driver always has priority in using the hands-free gateway 100. It is generally considered not a hazard when a passenger talks on a hand-held mobile phone.

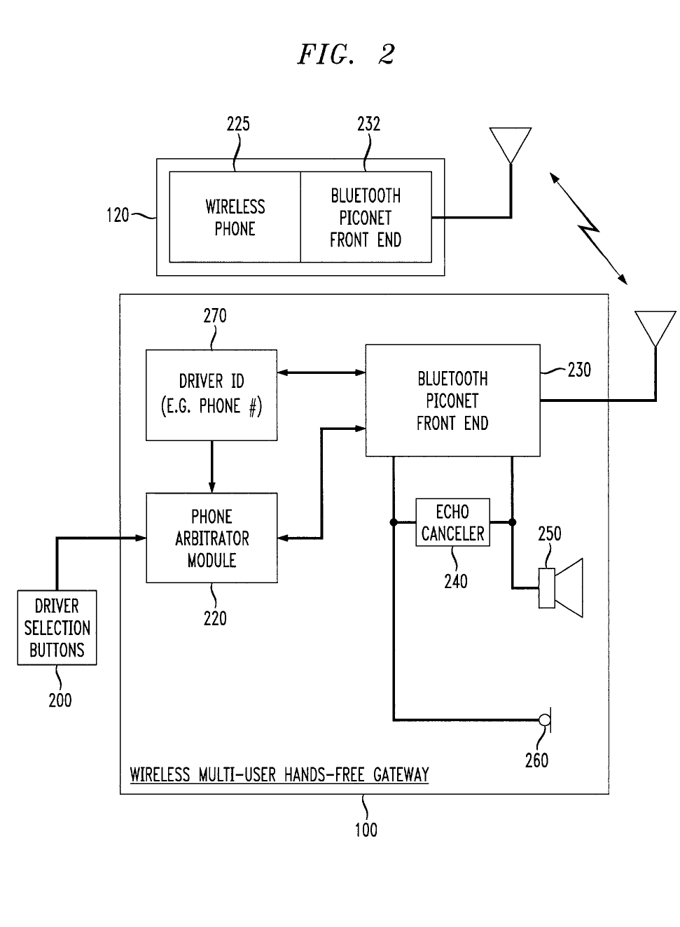

FIG. 2 is a detailed block diagram of a multi-user wireless hands-free gateway in accordance with the principles of the present invention.

In particular, FIG. 2 shows a wireless phone 120 including an otherwise conventional wireless phone functionality 225 in communication with a BLUETOOTH™ piconet front end 232. The BLUETOOTH™ piconet front end 232 may communicate with a processor in the wireless phone functionality 225 using any suitable communication device and standard, serial or parallel.

The wireless phones 120 each establish a piconet network with the wireless multi-user hands-free gateway 100, which includes a BLUETOOTH™ piconet front end 230, a loudspeaker 250 (or interconnection to the vehicle's sound system), a microphone 250, and a suitable audio echo canceller 240. The audio echo canceller 240 provides cancellation of feedback components picked up by the microphone 260 from being output from the loudspeaker 250.

The wireless multi-user hands-free gateway 100 also includes the identification of the driver's wireless phone so that priority usage can be given to the driver of the vehicle 101. While any unique identifier may be used, the telephone number of the driver's wireless phone 120a is used and stored in an appropriate register or memory location 270 in the given embodiments.

The selection of a particular driver may be performed using any suitable technique. For instance, the telephone number of possible drivers may be programmed and stored in the driver ID module 270 using any suitable keypad in the vehicle in communication with the wireless hands-free gateway 100.

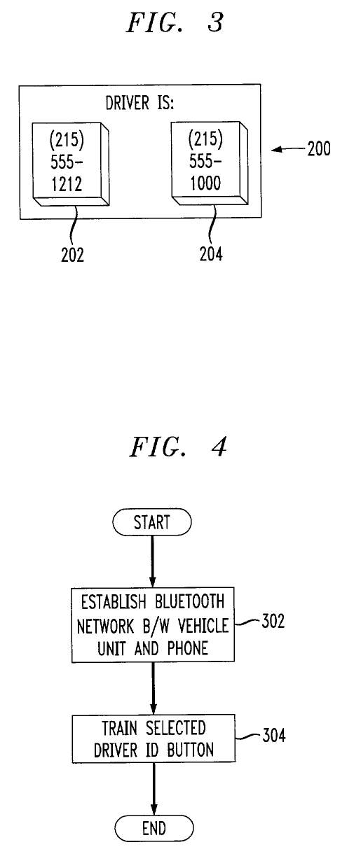

FIG. 3 is an exemplary vehicle control panel which, once trained with appropriate wireless phone Ids (e.g., phone numbers), allows a driver of the vehicle to identify themselves as such so that their wireless phone is given priority usage of the vehicle's wireless multi-user hands-free unit, in accordance with the principles of the present invention.

In particular, FIG. 3 shows a control panel including two push-buttons 202, 204 corresponding to two possible drivers of the vehicle 101 in which it is installed. In the given embodiment, each push-button is initially trained to correspond to a particular driver's ID (e.g., their wireless phone number). Thereafter, a driver selects the correct button 202 or 204 corresponding to their wireless phone to gain priority use of the wireless multi-user hands-free gateway 100. Preferably, the driver selects the correct button 202, 204 before an incoming call is received by their wireless phone, so that priority access can be provided immediately upon receipt of the incoming phone call.

FIG. 4 is an exemplary process flow chart showing the training of the vehicle control panel shown in FIG. 3.

In particular, in step 302 of FIG. 4, a piconet network (e.g., a BLUETOOTH™ conforming piconet network connection is established between the wireless multi-user hands-free gateway 100 and the particular wireless phone 120 training the driver selection control panel 200.

In step 304, as part of the training process, the user is prompted to activate one of the buttons 202 or 204 on the driver selection control panel 200 to ‘program’ that particular button 202 or 204 with the identity (e.g., phone number) of that potential driver.

The same process is repeated for each potential driver to program the remaining buttons in the driver selection control panel 200.

Instead of push-buttons 202, 204 as shown in FIG. 3, a toggle button may be implemented that toggles between selections of wireless phones in the piconet network to identify which user is the driver. In another embodiment, a rotary or other multiple position switch may be implemented to select the identity of the driver.

While buttons and switches are shown in the embodiments of FIGS. 2-4 to identify which wireless phone is the driver, any suitable indication of the driver's wireless phone with respect to other wireless phones in an established piconet network may be utilized. In accordance with the principles of the present invention, it is preferred that there be a clear indication presented to the wireless multi-user hands-free unit of which in-range user is the driver such that the wireless multi-user hands-free gateway 100 will properly provide hands-free capabilities to the desired wireless phone 120 in the vehicle 101 at the appropriate time.

In yet another embodiment, a user in a backseat or other passenger seat of the vehicle 101 may be provided with the ability to use the wireless multi-user hands-free gateway 100 via a control panel button presented near their passenger seat.

Alternatively, the driver identity selection may be performed using voice recognition. For instance, voice recognition may determine which of a known set of voices is speaking. In such an embodiment, the phone arbitration module 200 of the wireless multi-user hands-free gateway 100 may be first trained using various sentences spoken by each possible user in the vehicle 101.

More advanced uses of voice recognition may also be implemented. For instance, the user of the wireless multi-user hands-free gateway 100 may speak the digits in a desired telephone number to be placed, with the digits being converted into numerals of a phone number and communicated to a service provider to make the phone call.

Referring back to FIG. 2, a phone arbitration module 220 arbitrates access and usage of the wireless multi-user hands-free gateway 100, giving priority usage to the driver's wireless phone, and first come-first served priority to passengers in the vehicle other than the driver. Preferably, acknowledgement of access to a particular wireless phone 120 is provided by the wireless hands-free gateway 100 back to the successful wireless phone 120 given access and use of the hands-free functionality of the wireless hands-free gateway 100.

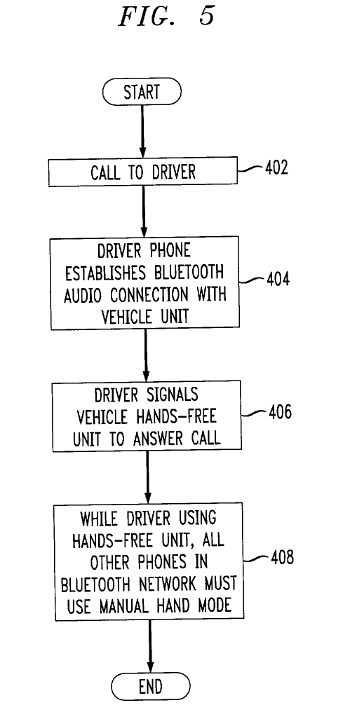

The phone arbitration module 220 may be implemented as software within a suitable processor. The functionality of the disclosed phone arbitration module 220 is shown and described with respect to FIGS. 5 to 8.

The driver selection control panel 200 may be located in any convenient location within the vehicle, e.g., on the steering wheel, in a corner of the windshield, on one or more doors in the vehicle, etc.

In yet another embodiment, automatic designation of a particular user as a ‘default’ driver may be established, e.g., by the first user during the current drive to make use of the wireless hands-free gateway 100.

FIG. 5 is an exemplary process flow chart showing the usage of the wireless multi-user hands-free gateway by the driver of the vehicle, in accordance with the principles of the present invention.

In particular, in step 402 of FIG. 5, an incoming call is received by the current driver of the vehicle 101.

In step 404, the driver's wireless phone 120a establishes a BLUETOOTH™ audio connection with the wireless multi-user hands-free gateway 100.

In step 406, the driver's wireless phone 120a signals the wireless multi-user hands-free gateway 100 to answer the incoming call.

In step 408, while the driver utilizes the hands-free functionality of the wireless hands-free gateway 100, all other wireless phones in the BLUETOOTH network (i.e., within the vehicle 101) are not provided hands-free access, and thus must use their manual hands mode.

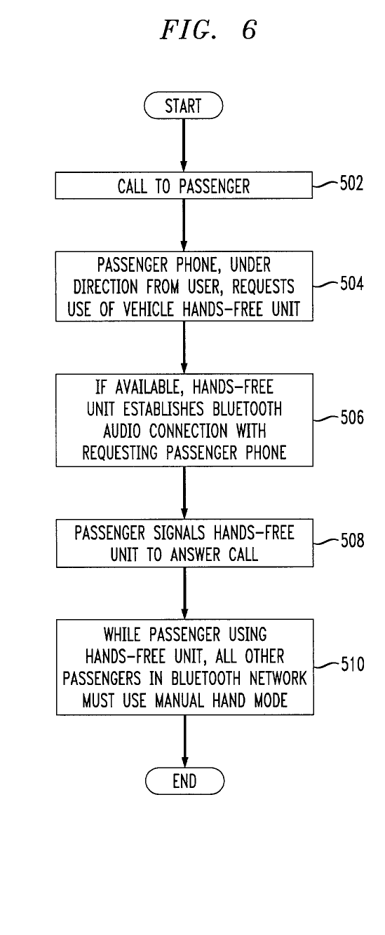

FIG. 6 is an exemplary process flow chart showing the usage of the wireless multi-user hands-free gateway by a passenger of the vehicle, in accordance with the principles of the present invention.

In particular, in step 502 of FIG. 6, one of the passengers in the vehicle 101 receives an incoming call.

In step 504, the passenger's wireless phone, under the direction of the passenger, requests use of the wireless hands-free gateway 100. Typically, this request may be performed by keypress on the passenger's wireless phone, but may alternatively be activated by a button mounted in the vehicle adjacent the passenger and in communication with the wireless hands-free gateway 100.

In step 506, if available (i.e., not currently being used), the wireless hands-free gateway 100 establishes a two-way BLUETOOTH™ audio connection with the requesting passenger's wireless phone.

In step 508, the passenger's wireless phone signals the wireless hands-free gateway 100 to answer the incoming phone call.

In step 510, while the passenger makes use of the hands-free functionality, all other passengers in the vehicle 101 are directed to use their manual mode (provided that all passenger's wireless phones are given equal priority and arbitration is provided on a first come-first served basis).

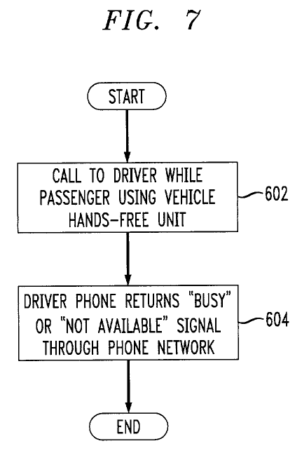

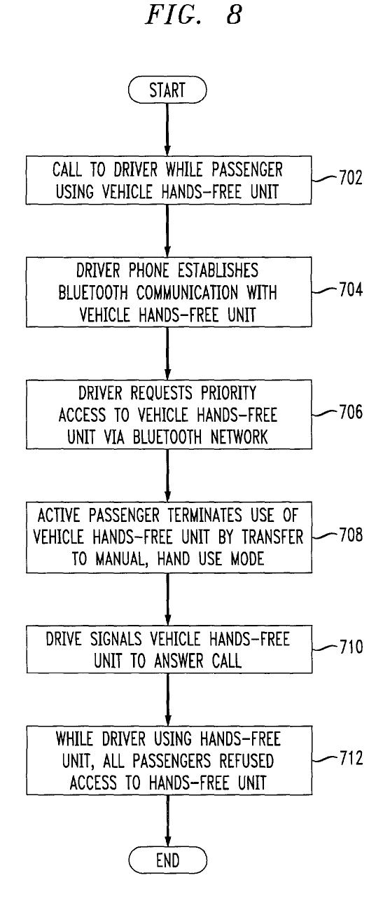

FIG. 7 is an exemplary process flow chart showing a first option wherein the driver of the vehicle returns a busy or not available signal if an incoming call is received while another passenger in the vehicle is using the wireless multi-user hands-free gateway, in accordance with the principles of the present invention.

In particular, in step 602 of FIG. 7, the driver of the vehicle 101 receives an incoming call while a passenger is using the hands-free functionality of the wireless hands-free gateway 100. In accordance with the principles of the present invention, the driver is given priority usage of the wireless hands-free unit or in any event hands mode is avoided for the driver.

To this end, step 604 shows that hands mode for the driver is avoided by returning a “busy”, “not available” or similar signal back to its service provider. In the given embodiment, the caller receives a busy or not available signal in accordance with otherwise conventional telephone standards.

FIG. 8 is an exemplary process flow chart showing a second option wherein if an incoming call is received by the driver while another passenger in the vehicle is using the wireless multi-user hands-free gateway, the passenger is directed to terminate use of the wireless multi-user hands-free unit (either by returning to hand mode or by terminating telephone call), to provide priority usage of the wireless multi-user hands-free gateway in accordance with the principles of the present invention.

In particular, in step 702 of FIG. 8, the driver receives an incoming call while a passenger in the vehicle 101 uses the wireless hands-free gateway 100.

In step 704, the driver's wireless phone 120a establishes BLUETOOTH™ communications with the wireless hands-free gateway 100.

In step 706, the driver's wireless phone 120a requests priority access to the wireless hands-free gateway 100 via communications over the established piconet network.

In step 708, the active passenger terminates use of the wireless hands-free gateway 100 by transferring to manual, hands mode.

In step 710, the driver's wireless phone 120a signals the wireless hands-free unit 100 to establish a BLUETOOTH audio path therewith and to answer the incoming call.

In step 712, while the driver uses the wireless hands-free gateway 100, all passengers are preferably refused access to the wireless hands-free gateway until the driver's wireless phone has relinquished access thereto.

The vehicle 101 may provide user identification, particularly the identity of the driver, in other physical ways. For instance, the particular user (of a given set of pre-programmed and/or pre-trained possible users) may be identified, e.g., via a detected adjustment of the driver's seat, of a selected radio station, etc. Any physical technique may be implemented to determine which user is the driver of the vehicle 101, in accordance with the principles of the present invention.

For instance, in another embodiment in accordance with the principles of the present invention utilizes a key chain-mounted electronically detectable tag to provide the identity of the driver of the vehicle.

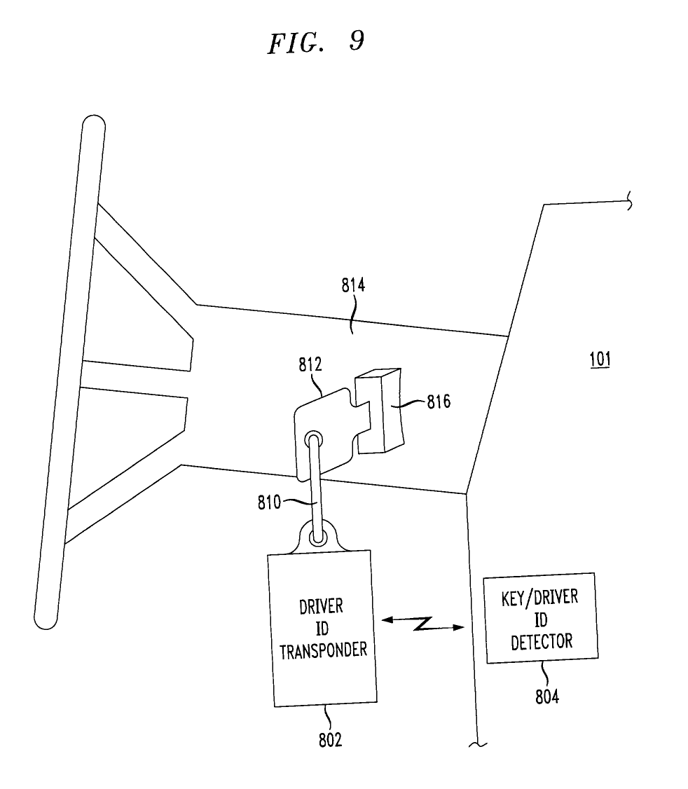

FIG. 9 shows the use of a driver ID transponder to automatically inform the wireless multi-user hands-free gateway as to which user within range of the BLUETOOTH™ piconet is the driver of the vehicle, in accordance with the principles of the present invention.

In particular, FIG. 9 shows a key chain 810-carried driver ID transponder 802 placed in proximity to a mating key/driver ID detector 804 when the owner's car key 812 is placed in the ignition 816 of the vehicle 101. When the driver's key 812 is inserted into the ignition, their ID is detected by the key/driver ID detector 804, and provided to the phone arbitrator module 220 of the wireless hands-free gateway 100 for storage in the driver ID register or memory 270.

Any suitable detection technology may be implemented in the driver ID transponder 802 and key/driver ID detector 804. For instance, suitable technology is disclosed in co-pending U.S. application Ser. No. 09/783,101 entitled “Recharging Key Based Wireless Device”, filed Feb. 15, 2001 by Philip D. Mooney et al., the entirety of which is expressly incorporated herein by reference.

Implementation of a wireless hands-free gateway 100 in accordance with the principles of the present invention need not be limited to vehicles, but rather can be extended for use in homes and offices.

The wireless hands-free gateway 100 may be speech activated. For instance, key words may be pre-trained and used to select which wireless phone is requesting access to the wireless hands-free gateway 100. For example, user one could say “Using Smith, call the office.” The words “Using Smith” would select user one, and “call the office” would select the telephone number to call. These gateway selection key words may be configured and/or trained during piconet device pairing.

A wireless hands-free vehicle unit in accordance with the principles of the present invention improves safety by encouraging hands-free operation of wireless devices, particularly that of the driver. Moreover, such a hands-free unit would tend to increase usage of wireless services by making calling more convenient. Preferably, the multi-user wireless hands-free unit enhances the user's experience by making user selection automatic. It also has the capability of providing accurate usage information by allowing co-workers in a common vehicle to share a single hands-free unit, thus eliminating the need for a secondary user to borrow another's phone which mates with a single conventional hands-free unit.

The present invention can be adapted for use in car rentals, allowing generic hands-free capabilities to all travelers. It also allows for hands-free conference calls in a vehicle.

While the invention has been described with reference to the exemplary embodiments thereof, those skilled in the art will be able to make various modifications to the described embodiments of the invention without departing from the true spirit and scope of the invention.

What is claimed is:

1. A wireless hands-free device, comprising:
a piconet front end adapted to establish an audio path with a wireless phone over a piconet network; and
a speakerphone functionality module.

2. The wireless hands-free device according to claim 1, wherein:
said piconet network conforms to BLUETOOTH™ standards.

3. The wireless hands-free device according to claim 1, wherein:
said speakerphone functionality module includes an echo canceller.

4. The wireless hands-free device according to claim 1, wherein:
said speakerphone functionality module is adapted to interface with an external sound system of a vehicle.

5. The wireless hands-free device according to claim 1, further comprising:
a driver ID register/memory adapted for storage of a unique identification of a current driver of a vehicle.

6. The wireless hands-free device according to claim 1, further comprising:
a phone arbitrator module adapted to provide arbitrated access to any one of a plurality of wireless phones participating in said piconet network.

7. The wireless hands-free device according to claim 6, further comprising:
an external selection control mounted for access by a user directing said wireless hands-free device as to which participant in said piconet network has a highest priority for usage of said wireless hands-free device.

8. A method of providing hands-free functionality to one of a plurality of wireless phones participating in a piconet network, comprising:
receiving a request for access to a wireless hands-free gateway from one of said plurality of wireless phones; and
providing hands-free functionality to said one of said plurality of wireless phones.

9. The method of providing hands-free functionality to one of a plurality of wireless phones participating in a piconet network according to claim 8, wherein:
said piconet network is established within a vehicle.

10. The method of providing hands-free functionality to one of a plurality of wireless phones participating in a piconet network according to claim 9, further comprising:
determining which of a plurality of participants in a piconet network is a current driver of a vehicle.

11. The method of providing hands-free functionality to one of a plurality of wireless phones participating in a piconet network according to claim 10, further comprising:
if said one of said plurality of wireless phones is a driver of said vehicle, denying access to any other one of said plurality of wireless phones until said one of said plurality of wireless phones has completed its use of said hands-free functionality.

12. The method of providing hands-free functionality to one of a plurality of wireless phones participating in a piconet network according to claim 10, further comprising:
providing a highest priority for access to said hands-free functionality to a driver of a vehicle.

13. Apparatus for providing hands-free functionality to one of a plurality of wireless phones participating in a piconet network, comprising:
means for receiving a request for access to a wireless hands-free gateway from one of said plurality of wireless phones; and
means for providing hands-free functionality to said one of said plurality of wireless phones.

14. The apparatus for providing hands-free functionality to one of a plurality of wireless phones participating in a piconet network according to claim 13, wherein:
said piconet network is established within a vehicle.

15. The apparatus for providing hands-free functionality to one of a plurality of wireless phones participating in a piconet network according to claim 14, further comprising:
means for determining which of a plurality of participants in a piconet network is a current driver of a vehicle.

16. The apparatus for providing hands-free functionality to one of a plurality of wireless phones participating in a piconet network according to claim 15, further comprising:
means for denying access to any other one of said plurality of wireless phones until said one of said plurality of wireless phones has completed its use of said hands-free functionality, if said one of said plurality of wireless phones is a driver of said vehicle.

17. The method of providing hands-free functionality to one of a plurality of wireless phones participating in a piconet network according to claim 15, further comprising:
means for providing a highest priority for access to said hands-free functionality to a driver of a vehicle.

18. A method of providing hands-free functionality to a wireless phone participating in a piconet network, comprising:
receiving a request for access to a wireless hands-free gateway from said wireless phone; and
providing hands-free functionality to said wireless phone.

19. The method of providing hands-free functionality to a wireless phone participating in a piconet network according to claim 18, wherein:
said piconet network is established within a vehicle.

20. The method of providing hands-free functionality to a wireless phone participating in a piconet network according to claim 19, further comprising:
determining which of a plurality of participants in a piconet network is a current driver of a vehicle.

21. The method of providing hands-free functionality to a wireless phone participating in a piconet network according to claim 20, further comprising:
denying access to any other wireless phones until said wireless phone determined to be used by a driver of said vehicle has completed their use of said hands-free functionality.

22. The method of providing hands-free functionality to a wireless phone participating in a piconet network according to claim 20, further comprising:
providing a highest priority for access to said hands-free functionality to a driver of a vehicle.
